(19) United States
(12) Patent Application Publication
(10) Pub. No.: US 2025/0364845 A1
(43) Pub. Date: Nov. 27, 2025

(54) Determining Power Transfer Profiles for Wireless Power Transfer Devices

(71) Applicant: Apple Inc., Cupertino, CA (US)

(72) Inventors: Alin I. Gherghescu, Campbell, CA (US); Zaid A. AbuKhalaf, Sunnyvale, CA (US)

(21) Appl. No.: 19/182,384

(22) Filed: Apr. 17, 2025

Related U.S. Application Data
(60) Provisional application No. 63/644,083, filed on May 8, 2024.

(51) Int. Cl. H02J 50/80; H02J 7/00; H02J 50/10

(52) U.S. Cl. CPC H02J 50/80; H02J 50/10; H02J 7/00034; H02J 7/00712; H02J 2207/20

(57) ABSTRACT

A wireless charging system may include a wireless power receiving device that receives wireless power signals from a wireless power transmitting device. The wireless power receiving device may transmit received power information to the wireless power transmitting device. The wireless power transmitting device may determine a recommended power transfer profile using at least the received power information. The wireless power transmitting device may transmit the recommended power transfer profile to the wireless power receiving device.

This application claims the benefit of U.S. provisional patent application No. 63/644,083, filed May 8, 2024, which is hereby incorporated by reference herein in its entirety.

### FIELD

This relates generally to power systems including wireless power systems for charging electronic devices.

### BACKGROUND

In a wireless charging system, a wireless power transmitting device transmits wireless power to a wireless power receiving device. The wireless power receiving device charges a battery and/or powers components using the wireless power. The efficiency of the wireless charging system may vary depending on various conditions within the wireless charging system.

### SUMMARY

An electronic device may include a wireless power transfer coil, an inverter that is configured to supply alternating-current drive signals to the wireless power transfer coil, and control circuitry configured to commence wireless power transfer to an additional electronic device using a first power transfer profile, receive, during wireless power transfer to the additional electronic device using the first power transfer profile, a first packet from the additional electronic device that comprises received power information for the additional electronic device, determine, using at least the received power information, an optimum power transfer profile that is different than the first power transfer profile, and transmit a second packet to the additional electronic device that identifies the optimum power transfer profile. The first power transfer profile may define a target output characteristic of the wireless power transfer coil.

### BRIEF DESCRIPTION OF THE DRAWINGS

FIG. 1 is a schematic diagram of an illustrative wireless power system in accordance with some embodiments.

FIG. 2 is a circuit diagram of wireless power transmitting and receiving circuitry in accordance with some embodiments.

FIG. 3 is a side view of an illustrative wireless power transmitting device such as a wireless charging puck connected to a connector plug via a cable in accordance with some embodiments.

FIG. 4 is a diagram of an illustrative wireless power system showing different power levels at different locations within the system in accordance with some embodiments.

FIG. 5 is a flowchart of illustrative communications within a wireless power system in which a power transmitting device recommends a power transfer profile to a power receiving device in accordance with some embodiments.

FIG. 6 is a graph of an illustrative curve of efficiency as a function of rectifier power level according to a low power transfer profile in accordance with some embodiments.

FIG. 7 is a graph of an illustrative curve of efficiency as a function of rectifier power level according to a medium power transfer profile in accordance with some embodiments.

FIG. 8 is a graph of an illustrative curve of efficiency as a function of rectifier power level according to a high power transfer profile in accordance with some embodiments.

FIG. 9 is a flowchart of an illustrative method that may be performed by a wireless power transmitting device in accordance with some embodiments.

FIG. 10 is a flowchart of an illustrative method that may be performed by a wireless power receiving device in accordance with some embodiments.

### DETAILED DESCRIPTION

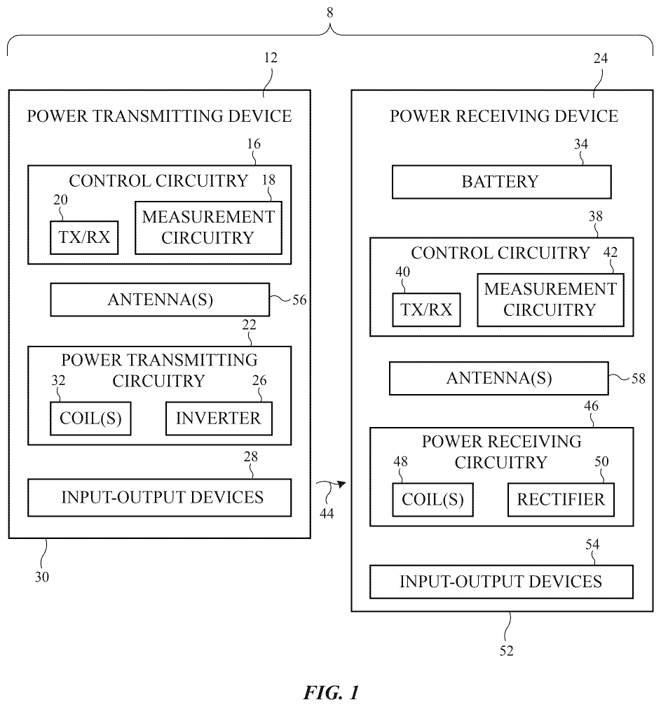

An illustrative wireless power system (also sometimes called a wireless charging system) is shown in FIG. 1. As shown in FIG. 1, wireless power system 8 may include one or more wireless power transmitting devices such as wireless power transmitting device 12 and one or more wireless power receiving devices such as wireless power receiving device 24. Wireless power system 8 may sometimes also be referred to herein as wireless power transfer (WPT) system 8 or wireless power system 8. Wireless power transmitting device 12 may sometimes also be referred to herein as power transmitter (PTX) device 12 or simply as PTX 12. Wireless power receiving device 24 may sometimes also be referred to herein as power receiver (PRX) device 24 or simply as PRX 24.

PTX device 12 includes control circuitry 16. Control circuitry 16 is mounted within housing 30. PRX device 24 includes control circuitry 38 mounted within a corresponding housing 52 for PRX device 24. Exemplary control circuitry 16 and control circuitry 38 are used in controlling the operation of WPT system 8. This control circuitry may include processing circuitry that includes one or more processors such as microprocessors, power management units, baseband processors, digital signal processors, microcontrollers, graphics processing units (GPUs), central processing units (CPUs), application processors (APs), application-specific integrated circuits with processing circuits, and/or other processing circuits. The processing circuitry implements desired control and communications features in PTX device 12 and PRX device 24. For example, the processing circuitry may be used in controlling power to one or more coils, determining and/or setting power transmission levels, generating and/or processing sensor data (e.g., to detect foreign objects and/or external electromagnetic signals or fields), processing user input, handling negotiations between PTX device 12 and PRX device 24, sending and receiving in-band and out-of-band data, making measurements, and/or otherwise controlling the operation of WPT system 8.

Control circuitry in WPT system 8 (e.g., control circuitry 16 and/or 38) is configured to perform operations in WPT system 8 using hardware (e.g., dedicated hardware or circuitry), firmware and/or software. Software code for performing operations in WPT system 8 is stored on non-transitory computer readable storage media (e.g., tangible computer readable storage media) in the control circuitry of WPT system 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 38.

PTX device 12 may be a stand-alone power adapter (e.g., a wireless charging mat or charging puck that includes power adapter circuitry), may be a wireless charging mat or puck that is connected to a power adapter or other equipment by a cable, may be an electronic device (e.g., a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment), may be equipment that has been incorporated into furniture, a vehicle, or other system, may be a removable battery case, or may be other wireless power transfer equipment.

PRX device 24 may be an electronic device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a wireless tracking tag, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment.

PTX device 12 may be connected to a wall outlet (e.g., an alternating current power source), may be coupled to a wall outlet via an external power adapter, may have a battery for supplying power, and/or may have another source of power. In implementations where PTX device 12 is coupled to a wall outlet via an external power adapter, the adapter may have an alternating-current (AC) to direct-current (DC) power converter that converts AC power from a wall outlet or other power source into DC power. If desired, PTX device 12 may include a DC-DC power converter for converting the DC power between different DC voltages. Additionally or alternatively, PTX device 12 may include an AC-DC power converter that generates the DC power from the AC power provided by the wall outlet (e.g., in implementations where PTX device 12 is connected to the wall outlet without an external power adapter). DC power may be used to power control circuitry 16. During operation, a controller in control circuitry 16 uses power transmitting circuitry 22 to transmit wireless power to power receiving circuitry 46 of PRX device 24.

Power transmitting circuitry 22 may have switching circuitry, such as inverter circuitry 26 formed from transistors, that is turned on and off based on control signals provided by control circuitry 16 to create AC current signals through one or more wireless power transmitting coils such as wireless power transmitting coil(s) 32. These coil drive signals cause coil(s) 32 to transmit wireless power. In implementations where coil(s) 32 include multiple coils, the coils may be disposed on a ferromagnetic structure, arranged in a planar coil array, or may be arranged to form a cluster of coils (e.g., two or more coils, 5-10 coils, at least 10 coils, 10-30 coils, fewer than 35 coils, fewer than 25 coils, or other suitable number of coils). In some implementations, PTX device 12 includes only a single coil 32.

As the AC currents pass through one or more coils 32, alternating-current electromagnetic (e.g., magnetic) fields (wireless power signals 44) are produced that are received by one or more corresponding receiver coils such as coil(s) 48 in PRX device 24. In other words, one or more of coils 32 is inductively coupled to one or more of coils 48. PRX device 24 may have a single coil 48, at least two coils 48, at least three coils 48, at least four coils 48, or another suitable number of coils 48. When the alternating-current electromagnetic fields are received by coil(s) 48, corresponding alternating-current currents are induced in coil(s) 48. The AC signals that are used in transmitting wireless power may have any desired frequency (e.g., 100-400 kHz, 1-100 MHz, between 1.7 MHz and 1.8 MHz, less than 2 MHz, between 100 kHz and 2 MHz, etc.). Rectifier circuitry such as rectifier circuitry 50, which contains rectifying components such as synchronous rectification transistors arranged in a bridge network, converts received AC signals (received alternating-current signals associated with wireless power signals 44) from one or more coils 48 into DC voltage signals for powering PRX device 24. Wireless power signals 44 are sometimes referred to herein as wireless power 44 or wireless charging signals 44. Coils 32 are sometimes referred to herein as wireless power transfer coils 32, wireless charging coils 32, or wireless power transmitting coils 32. Coils 48 are sometimes referred to herein as wireless power transfer coils 48, wireless charging coils 48, or wireless power receiving coils 48.

The DC voltage produced by rectifier circuitry 50 (sometime referred to as rectifier output voltage V_{RECT_DC}) may be used in charging a battery such as battery 34 and may be used in powering other components in PRX device 24 such as control circuitry 38, input-output (I/O) devices 54, etc. PTX device 12 may also include input-output devices such as input-output devices 28. Input-output devices 54 and/or input-output devices 28 may include input devices for gathering user input and/or making environmental measurements and may include output devices for providing a user with output.

As examples, input-output devices 28 and/or input-output devices 54 may include a display (screen) for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 28 and/or input-output devices 54 may also include sensors for gathering input from a user and/or for making measurements of the surroundings of WPT system 8.

The example in FIG. 1 of PRX device 24 including battery 34 is illustrative. More generally, an electronic device may include a power storage device 34. Power storage device 34 may be a battery, or may be, for example, a supercapacitor that stores charge.

PTX device 12 and PRX device 24 may communicate wirelessly using in-band or out-of-band communications. Implementations using in-band communication may utilize, for example, frequency-shift keying (FSK) and/or amplitude-shift keying (ASK) techniques to communicate in-band data between PTX device 12 and PRX device 24. Wireless power and in-band data transmissions may be conveyed using coils 32 and 48 concurrently. When PTX 12 sends in-band data to PRX 24, wireless transceiver (TX/RX) circuitry 20 may modulate wireless charging signal 44 to impart FSK or ASK communications, and wireless transceiver circuitry 40 may demodulate the wireless charging signal 44 to obtain the data that is being communicated. When PRX 24 sends in-band data to PTX 12, wireless transceiver (TX/RX) circuitry 40 may modulate wireless charging signal 44 to impart FSK or ASK communications, and wireless transceiver circuitry 20 may demodulate the wireless charging signal 44 to obtain the data that is being communicated.

Implementations using out-of-band communication may utilize, for example, hardware antenna structures and communication protocols such as Bluetooth or NFC to communicate out-of-band data between PTX device 12 and PRX device 24. Power may be conveyed wirelessly between coils 32 and 48 concurrently with the out-of-band data transmissions. Wireless transceiver circuitry 20 may wirelessly transmit and/or receive out-of-band signals to and/or from PRX device 24 using an antenna such as antenna 56. Wireless transceiver circuitry 40 may wirelessly transmit and/or receive out-of-band signals to and/or from PTX device 12 using an antenna such as antenna 58.

Control circuitry 16 in PTX device 12 has measurement circuitry 18 that may be used to perform measurements of one or more characteristics external to PTX device 12. For example, measurement circuitry 18 may detect external objects on or adjacent the charging surface of the housing of PTX device 12. While shown in FIG. 1 as being separate from power transmitting circuitry 22 for the sake of clarity, measurement circuitry 18 may form a part of power transmitting circuitry 22 if desired.

Measurement circuitry 18 may detect foreign objects such as coils, paper clips, and other metallic objects, may detect the presence of PRX device 24 (e.g., circuitry 18 may detect the presence of one or more coils 48 and/or magnetic core material associated with coils 48), and/or may detect the presence of other power transmitting devices in the vicinity of PTX device 12 and/or WPT system 8. Measurement circuitry 18 may also be used to make sensor measurements using a capacitive sensor, may be used to make temperature measurements, and/or may otherwise be used in gathering information indicative of whether a foreign object, power transmitting device, power receiving device, or other external object (e.g., PRX device 24) is present on or adjacent to the coil(s) 32 of PTX device 12. If desired, PRX device 24 may include measurement circuitry 42. Measurement circuitry 42 may perform one or more of the measurements performed by measurement circuitry 18 (e.g., for or using coil(s) 48 on PRX device 24).

Each one of housing 30 and housing 52 may be formed from plastic, metal, fiber-composite materials such as carbon-fiber materials, wood and other natural materials, glass, other materials, and/or combinations of two or more of these materials.

The example in FIG. 1 of PTX 12 transmitting wireless power and PRX 24 receiving wireless power is merely illustrative. PTX 12 may optionally be capable of receiving wireless power signals using coil(s) 32 and PRX 24 may optionally be capable of transmitting wireless power signals using coil(s) 48. When a device is capable of both transmitting and receiving wireless power signals, the device may include both an inverter and a rectifier.

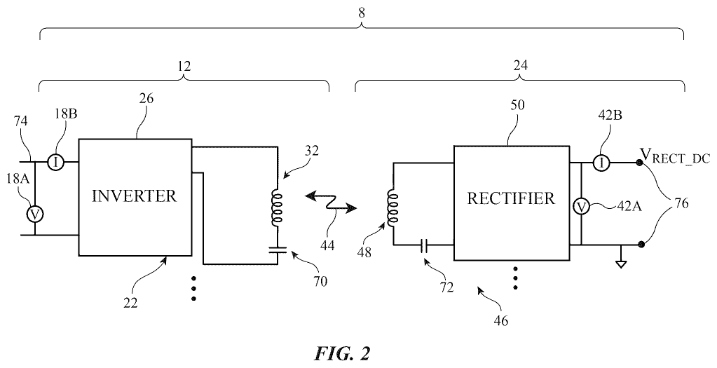

FIG. 2 is a circuit diagram of illustrative wireless charging circuitry for system 8. As shown in FIG. 2, circuitry 22 may include inverter circuitry such as one or more inverters 26 or other drive circuitry that produces wireless power signals that are transmitted through an output circuit that includes one or more coils 32 and capacitors such as capacitor 70. In some embodiments, device 12 may include multiple individually controlled inverters 26, each of which supplies drive signals to a respective coil 32. In other embodiments, an inverter 26 is shared between multiple coils 32 using switching circuitry.

During operation, control signals for inverter(s) 26 are provided by control circuitry 16 at one or more control inputs 74. A single inverter 26 and single coil 32 is shown in the example of FIG. 2, but multiple inverters 26 and multiple coils 32 may be used, if desired. In a multiple coil configuration, switching circuitry (e.g., multiplexer circuitry) may be used to couple a single inverter 26 to multiple coils 32 and/or each coil 32 may be coupled to a respective inverter 26. During wireless power transmission operations, transistors in one or more selected inverters 26 are driven by AC control signals from control circuitry 16. The relative phase between the inverters may be adjusted dynamically (e.g., a pair of inverters 26 may produce output signals in phase or out of phase).

The application of drive signals using inverter(s) 26 (e.g., transistors or other switches in circuitry 22) causes the output circuits formed from selected coils 32 and capacitors 70 to produce alternating-current electromagnetic fields (signals 44) that are received by wireless power receiving circuitry 46 using a wireless power receiving circuit formed from one or more coils 48 and one or more capacitors 72 in device 24.

Rectifier circuitry 50 is coupled to one or more coils 48 and converts received power from AC to DC and supplies a corresponding direct current output voltage V_{RECT_DC} across rectifier output terminals 76 for powering load circuitry in device 24 (e.g., for charging battery 34, for powering a display and/or other input-output devices 54, and/or for powering other components).

FIG. 2 shows how measurement circuitry 18 within PTX 12 may include one or more voltage sensors such as voltage sensor 18A and one or more current sensors such as current sensor 18B. Additionally, measurement circuitry 42 within PRX 24 may include one or more voltage sensors such as voltage sensor 42A and one or more current sensors such as current sensor 42B. The voltage and current sensors within system 8 may be used to determine power levels within the system.

The specific locations of sensors 18A, 18B, 42A, and 42B (on the DC sides of inverter 26 and rectifier 50 respectively) in FIG. 2 are merely illustrative. In general, voltage and current sensors may be positioned at any desired positions within the power transmitting circuitry 22 and the power receiving circuitry 46 (e.g., on the AC sides of inverter 26 and rectifier 50 if desired).

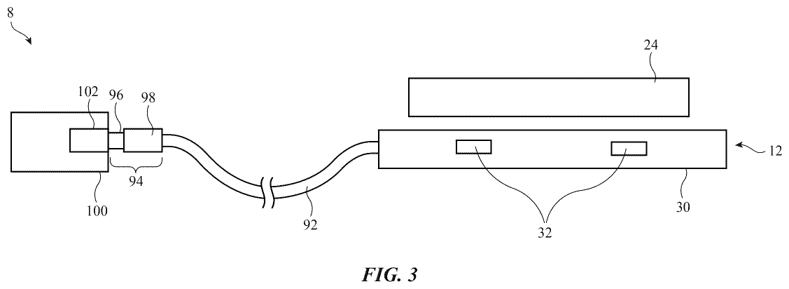

FIG. 3 is a cross-sectional side view of system 8 in an illustrative configuration in which wireless power transmitting device 12 is a wireless charging puck and in which wireless power receiving device 24 is a wristwatch, as an example. As shown in FIG. 3, device 12 has a device housing 30 (e.g., a disk-shaped puck housing formed form polymer, other dielectric material, and/or other materials). Device housing 30 may house a device microcontroller for communicating with plug 94, DC-DC power converter circuitry such as a step-down voltage converter (e.g., a buck converter), voltage regulator circuitry such as a low-dropout (LDO) regulator, wireless power transmitting circuitry such as inverter 26 (see FIG. 2), coil(s) 32, capacitor 70, near-field communications (NFC) circuitry for communicating with power receiving device 24, over-temperature protection (OTP) circuitry such as a temperature sensor, debug circuitry, filter circuitry, magnetic alignment structures such as magnets for attracting device 24 during charging operations, and/or other power transmitting device components.

Cable 92 is coupled to device housing 30 and provides power to coil(s) 32. One end of cable 92 may be pigtailed to housing 30. The opposing end of cable 92 is terminated using plug 94. Plug 94 has a boot portion 98 sometimes referred to as the “boot” of the plug. Cable 92 and plug 94 may be considered part of PTX 12 or may be considered a separate component from PTX 12. Boot 98, which may sometimes be referred to as a connector boot, may be formed from polymer, metal, and/or other materials and may have an interior region configured to house electrical components (e.g., integrated circuits, discrete components such as transistors, printed circuits, etc.). Boot 98 has a first end connected to cable 92 and a second end connected to a connector portion 96 (sometimes referred to as the “connector” of the plug). Connector 96 may include 24 pins, 10-30 pins, 10 or more pins, 20 or more pins, 30 or more pins, 40 or more pins, 50 or more pins, or any suitable number of pins supported within a connector housing. The pins within connector 96 are configured to mate with corresponding pins in port 102 of external equipment such as device 100. Device 100 may be a stand-alone power adapter that converts alternating-current (AC) power to direct-current (DC) power, an electronic device such as a computer, or other equipment that provides DC power to plug 94 through port 102. Port 102 may be, for example, a USB port (e.g., a USB type-C port, a USB 4.0 port, a USB 3.0 port, a USB 2.0 port, a micro-USB port, etc.) or a Lightning connector port. Plug 96 having a connector protruding from boot 98 may be referred to as a male plug. Plug 96 may be a reversible plug (i.e., a plug that may be mated with a corresponding connector port in at least two different and symmetrical orientations).

During operation of system 8, power receiving device 24 may be placed on the charging surface of power transmitting device 12. Device 24 and device 12 may have magnets (and/or magnetic material such as iron). For example, device 24 may have a magnet and device 12 may have a corresponding mating magnet. These magnets attract each other and thereby hold devices 12 and 24 together during charging.

Boot 98 may have a boot housing that houses various electrical components. The boot housing may house a boot microcontroller for communicating with the device microcontroller in housing 30, DC-DC power converter circuitry such as a step-up voltage converter (e.g., a boost converter), voltage regulator circuitry such as a low-dropout (LDO) regulator, electronic fuse circuitry such as an e-fuse or fuse for providing overcurrent protection when detecting short circuits, overloading, mismatched loads, or other device failure events, filter circuitry, and/or other boot components. In one illustrative arrangement, inverter 26 may be formed in boot 98 instead of in housing 30.

During wireless power transfer operations, it may be desirable to take suitable action based on the efficiency of wireless power transfer between PTX 12 and PRX 24. PTX 12 may report efficiency information to PRX 24 and/or PRX 24 may report efficiency information to PTX 12. The efficiency information may be transmitted using in-band communication (e.g., using coils 32 and 48) or using out-of-band communication (e.g., using antennas 56 and 58).

FIG. 4 shows the transfer of power through system 8. A power adapter 100 (such as the power adapter of FIG. 3) may receive power from a power source such as wall outlet 110. Wall outlet 110 may provide AC power at a first level P_{MAINS}. Power adapter 100 may convert the received AC power to DC power. The DC power output from power adapter may have a second level P_{ADPT}. A plug including boot portion 98 may be coupled to power adapter 100. Boot portion 98 may include power conversion circuitry that outputs DC power with a third level P_{BOOT}. The power output from boot portion 98 may be provided to inverter 26 within housing 30 (e.g., using cable 92 and/or other circuitry within power transmitting device 12). Inverter 26 uses the input power P_{BOOT} to create AC current signals through wireless power transmitting coil 32. The AC signals generated by inverter 26 and provided to transmitting (TX) coil 32 may have a fourth power level P_{INV}.

As the AC currents pass through one or more coils 32, alternating-current electromagnetic (e.g., magnetic) fields (wireless power signals 44) are produced that are received by one or more corresponding receiver coils such as coil(s) 48 in PRX device 24. The signals received at RX coil 48 may have a fifth power level P_{RECT_AC}. Rectifier 50 converts the AC power received at RX coil 48 to DC power at a sixth level P_{RECT_DC}.

There may be power inefficiency associated with each stage of the transfer of power through system 8. In other words, power adapter 100 has an associated power conversion and/or consumption inefficiency that causes P_{ADPT} to be less than P_{MAINS}, boot portion 98 has an associated power inefficiency that causes P_{BOOT} to be less than P_{ADPT}, inverter 26 has an associated power inefficiency that causes P_{INV} to be less than P_{BOOT}, wireless power transfer between TX coil 32 and RX coil 48 has an associated power inefficiency that causes P_{RECT_AC} to be less than P_{INV}, and rectifier 50 has an associated power inefficiency that causes P_{RECT_DC} to be less than P_{RECT_AC} (e.g., P_{MAINS}>P_{ADPT}>P_{BOOT}>P_{INV}>P_{RECT_AC}>P_{RECT_DC}).

In view of the varying power levels within wireless power system 8, there are many ways to characterize efficiency within the wireless power system. In general, efficiency may refer to a ratio of two power levels within the system, with the numerator's power level further downstream in the power transfer (and therefore lower) than the denominator's power level.

Efficiency of the wireless power transfer between PTX 12 and PRX 24 may be characterized by a ratio of at least one power level within PRX 24 and at least one power level within PTX 12 or power adapter 100. For example, the efficiency of wireless power transfer between PTX 12 and PRX 24 may be characterized as the ratio of P_{RECT_DC} and P_{INV} (e.g., Eff_{TRANSFER}=P_{RECT_DC}/P_{INV}).

An operating efficiency of PTX 12 may be characterized by a ratio of two power levels within PTX 12 or power adapter 100. For example, the operating efficiency of PTX 12 may be characterized as the ratio of P_{INV} and P_{ADPT} (e.g., Eff_{PTX}=P_{INV}/P_{ADPT}) or as the ratio of P_{INV} and P_{BOOT} (e.g., Eff_{PTX}=P_{INV}/P_{BOOT}).

Power is a function of current and voltage. The power at a given point within system 8 may therefore be determined using current information and/or voltage information at the given point within system 8. To obtain current information and/or voltage information to calculate a power level, measurement circuitry within each electronic device may include current sensors and/or voltage sensors. FIG. 2 shows how PTX 12 may include voltage sensor 18A and/or current sensor 18B. Information from these sensors may be used to determine the power level P_{INV} of inverter 26. FIG. 2 shows how PRX 24 may include voltage sensor 42A and/or current sensor 42B. Information from these sensors may be used to determine the power level P_{RECT_DC} of rectifier 50.

In general, current and/or voltage sensors at any desired locations within system 8 (e.g., within power adapter 100, within boot 98, within inverter 26, and/or within rectifier 50) may be used to determine current information and/or voltage information at a desired location within system 8. The current information and/or voltage information may then be used to determine a power level associated with the desired location within the system.

It should be noted that the magnitudes of efficiency levels, power levels, current levels, and/or voltage levels reported by PTX 12 and/or PRX 24 may be averaged over a time period. The duration of the time period may be predetermined and/or may be adjusted in real time.

PTX 12 and/or PRX 24 may operate according to a standard for wireless charging (e.g., the Qi standard as specified by the Wireless Power Consortium organization). The standard may include specifications for power levels, communication protocols, coil configurations, etc. The standard may include multiple power transfer profiles (sometimes referred to as power profiles or power transmission profile).

Each power transfer profile may include a different set of specifications that define how power is transferred between PTX 12 and PRX 24. The different power transfer profiles may ramp up power levels at different rates, have different maximum power transfer levels, etc. The different power transfer profiles may have different target output characteristics (e.g., frequency, power level (P_{INV}), etc.) for coil 32 in PTX 12. As one example, there may be three different power transfer profiles associated with PTX 12 and PRX 24. A first power transfer profile (sometimes referred to as a low power transfer profile) may have a first maximum power level (e.g., 5 W). A second power transfer profile (sometimes referred to as a medium power transfer profile) may have a second maximum power level (e.g., 9 W) that is greater than the first maximum power level. A third power transfer profile (sometimes referred to as a high power transfer profile) may have a third maximum power level (e.g., 15 W) that is greater than the second maximum power level.

Some electronic devices may support only one of these power transfer profiles. Some electronic devices may support all of these power transfer profiles. Some electronic devices may support some but not all of these power transfer profiles. When PTX 12 and PRX 24 do support multiple power transfer profiles, PTX 12 and/or PRX 24 may select which power transfer profile to use during a wireless power transfer session.

In one illustrative arrangement that will be described herein, PTX 12 may receive information from PRX 24 indicative of a received power level at PRX 24. Using at least the received power level information, PTX 12 may evaluate if the real time operating characteristics of PTX 12 and/or PRX 24 are within an optimum range for the power transfer profile currently being used. If PTX 12 determines that the real time operating characteristics of PTX 12 and/or PRX 24 are within the optimum range for the power transfer profile currently being used, PTX 12 may take no additional action (e.g., continue to use the current power transfer profile). If PTX 12 determines that the real time operating characteristics of PTX 12 and/or PRX 24 are not within the optimum range for the power transfer profile currently being used, PTX 12 may determine a new optimum power transfer profile associated with the real time operating characteristics. After determining the new optimum power transfer profile associated with the real time operating characteristics, PTX 12 may transmit a packet to PRX 24 that identifies the new optimum power transfer profile. PRX 24 may take suitable action based on this information. For example, PRX 24 may switch the power transfer profile to use the new optimum power transfer profile indicated by the packet received from PTX 12.

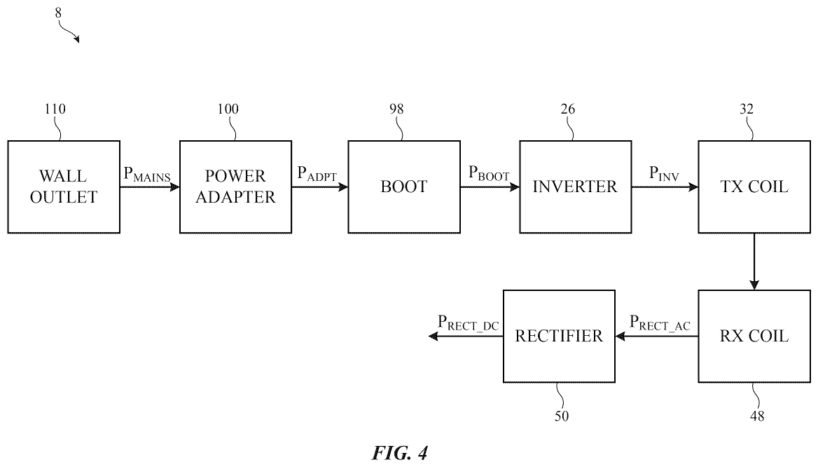

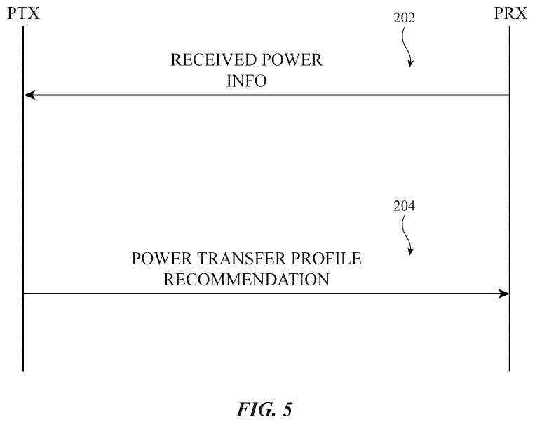

FIG. 5 is a flowchart showing illustrative communications in a wireless charging system where PTX 12 transmits a power transfer profile recommendation to PRX 24. As shown in FIG. 5, PRX 24 may first transmit a received power information packet 202 to PTX 12. Packet 202 may sometimes be referred to as a power loss accounting (PLA) packet or received power (RP) packet. The packet may include received power information (e.g., P_{RECT_DC} and/or V_{RECT_DC}).

In some cases, PTX 12 may use information from packet 202 for foreign object detection (FOD) operations (e.g., power loss accounting operations). Specifically, PTX 12 may use the received power information (from packet 202) and transmitted power information (as measured by circuitry 18) to estimate the amount of power loss caused by a foreign object in the vicinity of PTX 12 and/or PRX 24. If the estimated power loss caused by the foreign object is greater than a threshold, the PTX 12 may instruct PRX 24 to reduce its power consumption (e.g., reduce P_{RECT_DC}), may reduce the transmitted power level (e.g., P_{INV}), and/or may abort the power transfer.

Instead or in addition, PTX 12 may use the information from packet 202 to determine an optimum power transfer profile for the wireless power transfer from PTX 12 to PRX 24. After determining the optimum power transfer profile for the wireless power transfer from PTX 12 to PRX 24, PTX 12 may transmit a power transfer profile recommendation packet 204 to PRX 24. The power transfer profile recommendation packet (sometimes referred to as a power transfer profile instruction packet) 204 may identify one of the three possible power transfer profiles as the recommended power transfer profile for the real time operating conditions.

Each one of packets 202 and 204 may include numerous data bits (sometimes referred to as bits). The data bits may be grouped into bytes, with each byte including any desired number of bits (e.g., 8 bits).

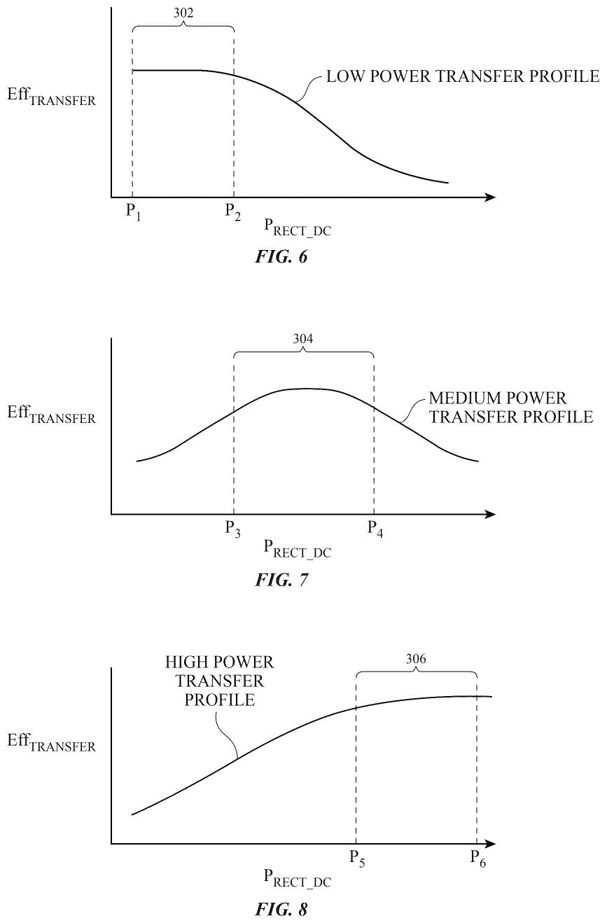

FIGS. 6-8 are graphs showing the efficiency of wireless power transfer between PTX 12 and PRX 24 (Eff_{TRANSFER}) as a function of rectifier power level (P_{RECT_DC}). FIG. 6 shows Eff_{TRANSFER} as a function of P_{RECT_DC} for the low power transfer profile, FIG. 7 shows Eff_{TRANSFER} as a function of P_{RECT_DC} for the medium power transfer profile, and FIG. 8 shows Eff_{TRANSFER} as a function of P_{RECT_DC} for the high power transfer profile.

As shown in FIGS. 6-8, the efficiency curve associated with each profile transmission profile may have an optimum efficiency within a given range. For the low power transfer profile, the optimum efficiency range 302 may be when the rectifier power level is between threshold power levels P₁ and P₂. For the medium power transfer profile, the optimum efficiency range 304 may be when the rectifier power level is between threshold power levels P₃ and P₄. For the high power transfer profile, the optimum efficiency range 306 may be when the rectifier power level is between threshold power levels P₅ and P₆.

It may be desirable to operate in the optimum efficiency range associated with the power transfer profile currently being used. After PTX 12 receives the packet 202 with received power information from PRX 24, PTX 12 may use the received power information to identify whether or not the real time operating conditions are within the optimum efficiency range associated with the power transfer profile currently being used.

Consider an example where the medium power transfer profile is being used when PTX 12 receives packet 202 from PRX 24. PTX 12 may use the information from packet 202 to determine whether the real time operating conditions are within optimum efficiency range 304 of FIG. 7. If the real time operating conditions are within optimum efficiency range 304 of FIG. 7, PTX 12 may continue to recommend the medium power transfer profile as the optimum power transfer profile for the wireless power transfer session. If the real time operating conditions are not within optimum efficiency range 304 of FIG. 7, PTX 12 may identify if the real time operating conditions are within optimum efficiency range 302 of FIG. 6 or optimum efficiency range 306 of FIG. 8. If the real time operating conditions are within optimum efficiency range 302 of FIG. 6, PTX 12 may recommend the low power transfer profile as the optimum power transfer profile for the wireless power transfer session. If the real time operating conditions are within optimum efficiency range 306 of FIG. 8, PTX 12 may recommend the high power transfer profile as the optimum power transfer profile for the wireless power transfer session.

PTX 12 may store various curves with associated thresholds that define optimum efficiency ranges in memory (e.g., in control circuitry 16). PTX 12 may select one of the stored curves (and associated optimum efficiency ranges) to identify whether the real time operating conditions fall within the optimum efficiency range based on various information.

PTX 12 may use information that identifies the device type of PRX 24 to select an appropriate curve with associated thresholds to identify whether the real time operating conditions fall within the optimum efficiency range. For example, a first device type (e.g., a watch) may have a first set of curves with first optimum efficiency ranges defined by first thresholds for the first, second, and third wireless power transfer profiles. A second device (e.g., a cellular telephone) may have a second set of curves with second optimum efficiency ranges defined by second thresholds for the first, second, and third wireless power transfer profiles. PRX 24 may transmit identification information that identifies its device type. If PRX 24 identifies itself as a watch, PTX 12 may use the first set of curves with the first optimum efficiency ranges when assessing the optimum power transfer profile. If PRX 24 identifies itself as a cellular telephone, PTX 12 may use the second set of curves with the second optimum efficiency ranges when assessing the optimum power transfer profile.

PTX 12 may use one or more operating parameters associated with power transmitting circuitry 22 to select an appropriate curve with associated thresholds to identify whether the real time operating conditions fall within the optimum efficiency range. Examples of such operating parameters include whether or not power transmitting circuitry 22 is in a soft switching mode or a hard switching mode, a current state of one or more tuning capacitors within power transmitting circuitry 22, etc. As a specific example, when power transmitting circuitry 22 is in a soft switching mode, PTX 12 may use a first set of curves with first optimum efficiency ranges when assessing the optimum power transfer profile. When power transmitting circuitry 22 is in a hard switching mode, PTX 12 may use a second set of curves with second optimum efficiency ranges when assessing the optimum power transfer profile. As another specific example, when the one or more tuning capacitors of power transmitting circuitry 22 are in a first state, PTX 12 may use a first set of curves with first optimum efficiency ranges when assessing the optimum power transfer profile. When the one or more tuning capacitors of power transmitting circuitry 22 are in a second state that is different than the first state, PTX 12 may use a second set of curves with second optimum efficiency ranges when assessing the optimum power transfer profile.

PTX 12 may therefore store various curves associated with different combinations of PRX device types, PTX operating parameters, etc. The various curves stored in control circuitry 16 of PTX 12 may be determined using calibration operations and/or derived from calibration information.

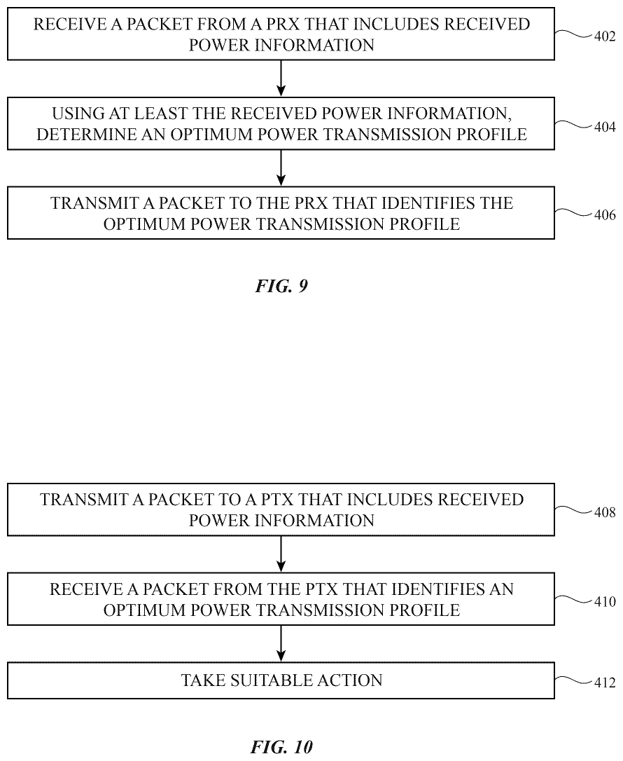

FIG. 9 is a flowchart of an illustrative method that may be performed by PTX 12 (e.g., control circuitry 16 in PTX 12). During the operations of block 402, PTX 12 may receive a packet from PRX 24 that includes received power information. The packet may be received using in-band communication (e.g., FSK or ASK demodulation) or using out-of-band communication using antenna 58 (e.g., Bluetooth or NFC communication). The packet received during the operations of block 402 may be a power loss accounting (PLA) packet or received power (RP) packet that includes received power information. The received power information may be determined using current and/or voltage sensors such as current sensor 42B and voltage sensor 42A in FIG. 2. Specifically, the received power information may include V_{RECT_DC}, P_{RECT_DC}, and/or other desired received power information.

It is noted that before the operations of block 402, PTX 12 and PRX 24 may commence a wireless power transfer session using a selected power transfer profile (e.g., either a low power transfer profile, a medium power transfer profile, or a high power transfer profile).

During the operations of block 404, PTX 12 may determine, using at least the received power information from block 402, a second power transfer profile that has more optimal power transfer between PTX 12 and the PRX 24 than the currently selected power transfer profile. The second power transfer profile may be most optimal power transfer profile of the available power transfer profiles for power transfer between PTX 12 and PRX 24 (based on the current operating conditions). PTX 12 may determine the second (optimum) power transfer profile using the received power information from block 402, one or more operating parameters associated with power transmitting circuitry 22, device identification information associated with PRX 24, and/or stored calibration information (e.g., a plurality of sets of curves associated with the low, medium, and high power transfer profiles at different real time operating conditions).

PTX 12 may use the rectifier power level of PRX 24 (as determined using the packet from block 402) and an inverter power level P_{INV} to derive the wireless power transfer efficiency Eff_{TRANSFER}.

PTX 12 may also use the device identification information associated with PRX 24 and/or the one or more operating parameters associated with power transmitting circuitry 22 to identify an appropriate set of efficiency curves for the low, medium, and high power transfer profiles (e.g., the curves of FIGS. 6-8). PTX 12 may select the curves for the low, medium, and high power transfer profiles that best match the current operating conditions (as dictated by the device identification information associated with PRX 24 and/or the one or more operating parameters associated with power transmitting circuitry 22).

After identifying the best-fit curves for the low, medium, and high power transfer profiles that best match the current operating conditions, PTX 12 may compare the real time efficiency Eff_{TRANSFER} and rectifier power level P_{RECT_DC} to the curve associated with the power transfer profile currently being used. If the real time Eff_{TRANSFER} and P_{RECT_DC} values correspond to an optimum efficiency range in the curve associated with power transfer profile currently being used, PTX 12 may determine that the power transfer profile currently being used remains the optimum power transfer profile. If the real time Eff_{TRANSFER} and P_{RECT_DC} values do not correspond to an optimum efficiency range in the curve associated with power transfer profile currently being used, PTX 12 may determine that the power transfer profile currently being used is no longer the optimum power transfer profile. PTX may subsequently compare the real time Eff_{TRANSFER} and P_{RECT_DC} values to the optimum efficiency ranges in the curves associated with other power transfer profiles to determine which of the other power transfer profiles is the new optimum power transfer profile.

The example the stored curves representing efficiency (Eff_{TRANSFER}) as a function of rectifier power level (P_{RECT_DC}) is merely illustrative. If desired, the curves may represent rectifier voltage (V_{RECT_DC}) as a function of rectifier power level (P_{RECT_DC}) and the real time rectifier voltage and rectifier power level may be used to assess whether or not the real time operating conditions are within an optimum range.

After determining the optimum power transfer profile, PTX 12 may transmit a packet to PRX 24 that identifies the optimum power transfer profile during the operations of block 406. The packet may be transmitted using in-band communication (e.g., FSK or ASK modulation) or using out-of-band communication using antenna 58 (e.g., Bluetooth or NFC communication). If the optimum power transfer profile is unchanged, PTX 12 may optionally forego transmitting the packet during the operations of block 406. Said another way, PTX 12 may only transmit the packet during the operations of block 406 when the optimum power transfer profile is changing from a first one of the three power transfer profiles to a second, different one of the three power transfer profiles.

The packet transmitted during the operations of block 406 may include one or more bits that identify the packet as a power transfer profile recommendation packet. The packet transmitted during the operations of block 406 may include one or more bits that identify a recommended power transfer profile.

It is further noted that, during the operations of block 404, care may be taken to prevent frequent switching between different recommended power transfer profiles. This may be achieved using a time buffer between changes in the optimum power transfer profile. For example, after changing the optimum power transfer profile there may be a delay period during which PTX 12 does not recommend changing the power transfer profile. Only after the delay period has concluded may PTX 12 recommend a new optimum power transfer profile to PRX 24. As another example, the optimum power transfer profile may be determined based on received power information that is averaged over a sufficiently long period of time to avoid rapid switching between optimum power transfer profiles.

When PTX 12 transmits the packet identifying a new optimum power transfer profile during the operations of block 406, PTX 12 may subsequently receive one or more communications from PRX 24 confirming that the PRX 24 is switching to the new optimum power transfer profile or that the PRX 24 is vetoing the new optimum power transfer profile and continuing to use the original optimum power transfer profile.

As a specific example, PTX 12 may commence a wireless power transfer session with PRX 24 using the medium power transfer profile. Before the operations of block 402, PTX 12 may receive device identification information from PRX 24 (e.g., information identifying that PRX 24 is a cellular telephone). During the operations of block 402, PTX 12 receives a packet from PRX 24 that identifies a real time P_{RECT_DC} for PRX 24. During the operations of block 404, PTX 12 may use the device identification information and power transmitting circuitry operating parameters to select representative curves for Eff_{TRANSFER} as a function of P_{RECT_DC} for the low, medium, and high power transfer profiles (such as the curves of FIGS. 6-8). The representative curves may have thresholds that identify optimum efficiency ranges for each curve (see optimum efficiency ranges 302, 304, and 306 in FIGS. 6-8).

During the operations of block 404, PTX 12 may derive Eff_{TRANSFER} using the received magnitude P_{RECT_DC} and the inverter power level P_{INV}. PTX 12 may then, during the operations of block 404, compare the real time Eff_{TRANSFER} and P_{RECT_DC} to the optimum efficiency range of the representative curve for the medium power transfer profile. If the real time Eff_{TRANSFER} and P_{RECT_DC} fall on the curve within the optimum efficiency range, PTX 12 may determine that the medium power transfer profile remains the optimum power transfer profile. In response to determining that the medium power transfer profile remains the optimum power transfer profile, PTX 12 may optionally transmit a packet to PRX 24 that identifies the medium power transfer profile as the recommended power transfer profile. Alternatively, since the optimum power transfer profile matches the power transfer profile currently being used, PTX 12 may take no further action and may reevaluate the optimum power transfer profile in response to the next received power packet from PRX 24 (e.g., the flowchart of FIG. 9 may loop back to block 402).

If the real time Eff_{TRANSFER} and P_{RECT_DC} do not fall on the curve within the optimum efficiency range, PTX 12 may determine that the medium power transfer profile is no longer the optimum power transfer profile. In response to determining that the medium power transfer profile is no longer the optimum power transfer profile, PTX 12 may, during the operations of block 404, compare the real time Eff_{TRANSFER} and P_{RECT_DC} to the optimum efficiency ranges of the representative curves for the low and high power transfer profiles. If the real time Eff_{TRANSFER} and P_{RECT_DC} fall on the curve for the low power transfer profile within the optimum efficiency range, PTX 12 may determine that the low power transfer profile is the new optimum power transfer profile. If the real time Eff_{TRANSFER} and P_{RECT_DC} fall on the curve for the high power transfer profile within the optimum efficiency range, PTX 12 may determine that the high power transfer profile is the new optimum power transfer profile. In this example, the real time Eff_{TRANSFER} and P_{RECT_DC} fall on the curve for the high power transfer profile within the optimum efficiency range and PTX 12 therefore determines that the high power transfer profile is the new optimum power transfer profile. After determining the new optimum power transfer profile, PTX 12 may, during the operations of block 406, transmit a packet to PRX 24 that identifies the high power transfer profile as the recommended power transfer profile. PTX 12 may subsequently receive one or more communications from PRX 24 confirming a switch to the high power transfer profile or vetoing the switch to the high power transfer profile.

FIG. 10 is a flowchart of an illustrative method that may be performed by PTX 24 (e.g., control circuitry 38 in PRX 24). During the operations of block 408, PRX 24 may transmit a packet to PTX 12 that includes received power information. The packet may be transmitted using in-band communication (e.g., FSK or ASK modulation) or using out-of-band communication using antenna 58 (e.g., Bluetooth or NFC communication). The packet transmitted during the operations of block 408 may be a power loss accounting (PLA) packet or received power (RP) packet that includes received power information. The received power information may be determined using current and/or voltage sensors such as current sensor 42B and voltage sensor 42A in FIG. 2. Specifically, the received power information may include V_{RECT_DC}, P_{RECT_DC}, and/or other desired received power information.

It is noted that before the operations of block 408, PTX 12 and PRX 24 may commence a wireless power transfer session using a selected power transfer profile (e.g., either a low power transfer profile, a medium power transfer profile, or a high power transfer profile).

Next, during the operations of block 410, PRX 24 may receive a packet from PTX 12 that identifies a recommended power transfer profile. The recommended power transfer profile may be more optimal for power transfer between PTX 12 and the PRX 24 than the currently selected power transfer profile. The recommended power transfer profile may be most optimal power transfer profile of the available power transfer profiles for power transfer between PTX 12 and PRX 24 (based on the current operating conditions). The packet may be received using in-band communication (e.g., FSK or ASK demodulation) or using out-of-band communication using antenna 58 (e.g., Bluetooth or NFC communication). The packet received during the operations of block 410 may include one or more bits that identify the packet as a power transfer profile recommendation packet. The packet received during the operations of block 410 may include one or more bits that identify a recommended power transfer profile.

After receiving the packet during the operations of block 410, PRX 24 may take suitable action during the operations of block 412. During the operations of block 412, PRX 24 may switch to the power transfer profile recommended by the packet received at block 410. PRX 24 may transmit one or more communications to PTX 12 confirming the switch in the power transfer profile, confirming a new target power level according to the new power transfer profile, etc. PRX 24 may optionally have veto-power over the recommendation received at block 410. In other words, PRX 24 may choose to continue to use a power transfer profile that is not recommended by the packet received at block 410. PRX 24 may transmit one or more communications to PTX 12 indicating that the switch in the power transfer profile has been vetoed.

The foregoing is merely illustrative and various modifications can be made to the described embodiments. The foregoing embodiments may be implemented individually or in any combination.

What is claimed is:

1. An electronic device comprising:
a wireless power transfer coil;
an inverter that is configured to supply alternating-current drive signals to the wireless power transfer coil; and
control circuitry configured to:
commence wireless power transfer to an additional electronic device using a first power transfer profile, wherein the first power transfer profile defines a target output characteristic of the wireless power transfer coil;
during wireless power transfer to the additional electronic device using the first power transfer profile, receive a first packet from the additional electronic device that comprises received power information for the additional electronic device;
using at least the received power information, determine a second power transfer profile, wherein the second power transfer profile provides more optimal power transfer between the electronic device and the additional electronic device than the first power transfer profile; and
transmit a second packet to the additional electronic device that identifies the second power transfer profile.

2. The electronic device of claim 1, wherein receiving the first packet comprises receiving the first packet using the wireless power transfer coil and wherein transmitting the second packet comprises transmitting the second packet using the wireless power transfer coil.

3. The electronic device of claim 2, wherein receiving the first packet comprises receiving the first packet using amplitude shift keying (ASK) demodulation and wherein transmitting the second packet comprises transmitting the second packet using frequency shift keying (FSK) modulation.

4. The electronic device of claim 1, wherein the received power information comprises a rectifier power level of the additional electronic device.

5. The electronic device of claim 4, wherein determining the second power transfer profile comprises:
determining a wireless power transfer efficiency between the electronic device and the additional electronic device using at least the received rectifier power level and using the determined wireless power transfer efficiency and the received rectifier power level to determine whether operation of the electronic device falls within a desired efficiency range for the first power transfer profile.

6. The electronic device of claim 5, wherein determining the second power transfer profile comprises:
in accordance with determining operation of the electronic device does not fall within the desired efficiency range for the first power transfer profile, identifying that the second power transfer profile is efficient at the determined wireless power transfer efficiency and the received rectifier power level, wherein the second power transfer profile defines one or more operating characteristics for the wireless power transfer coil that are different from the first wireless power transfer profile.

7. The electronic device of claim 5, wherein determining the wireless power transfer efficiency between the electronic device and the additional electronic device using at least the received rectifier power level comprises determining the wireless power transfer efficiency between the electronic device and the additional electronic device using the received rectifier power level and the target output characteristic of the wireless power transfer coil.

8. The electronic device of claim 5, wherein determining the second power transfer profile comprises:
determining that the determined wireless power transfer efficiency and the received rectifier power level are within an efficiency range on a curve associated with the second power transfer profile.

9. The electronic device of claim 8, wherein determining the second power transfer profile comprises:
identifying the curve associated with the second power transfer profile using device type information received from the additional electronic device and at least one operating parameter.

10. The electronic device of claim 1, wherein the second power transfer profile is the most optimal available power transfer profile for power transfer between the electronic device and the additional electronic device.

11. A method of operating an electronic device comprising a wireless power transfer coil and an inverter that is configured to supply alternating-current drive signals to the wireless power transfer coil, the method comprising:
commencing wireless power transfer to an additional electronic device using a first power transfer profile, wherein the first power transfer profile defines a target output characteristic of the wireless power transfer coil;
during wireless power transfer to the additional electronic device using the first power transfer profile, receiving a first packet from the additional electronic device that comprises received power information for the additional electronic device;
using at least the received power information, determining a second power transfer profile, wherein the second power transfer profile provides more optimal power transfer between the electronic device and the additional electronic device than the first power transfer profile; and
transmitting a second packet to the additional electronic device that identifies the second power transfer profile.

12. The method of claim 11, wherein receiving the first packet comprises receiving the first packet using the wireless power transfer coil and wherein transmitting the second packet comprises transmitting the second packet using the wireless power transfer coil.

13. The method of claim 12, wherein receiving the first packet comprises receiving the first packet using amplitude shift keying (ASK) demodulation and wherein transmitting the second packet comprises transmitting the second packet using frequency shift keying (FSK) modulation.

14. The method of claim 11, wherein the received power information comprises a rectifier power level of the additional electronic device.

15. The method of claim 14, wherein determining the second power transfer profile comprises:
determining a wireless power transfer efficiency between the electronic device and the additional electronic device using at least the received rectifier power level and using the determined wireless power transfer efficiency and the received rectifier power level to determine whether operation of the electronic device falls within a desired efficiency range for the first power transfer profile.

16. The method of claim 15, wherein determining the second power transfer profile comprises:
in accordance with determining operation of the electronic device does not fall within the desired efficiency range for the first power transfer profile, identifying that the second power transfer profile is efficient at the determined wireless power transfer efficiency and the received rectifier power level, wherein the second power transfer profile defines one or more operating characteristics for the wireless power transfer coil that are different from the first wireless power transfer profile.

17. The method of claim 15, wherein determining the wireless power transfer efficiency between the electronic device and the additional electronic device using at least the received rectifier power level comprises determining the wireless power transfer efficiency between the electronic device and the additional electronic device using the received rectifier power level and the target output characteristic of the wireless power transfer coil.

18. The method of claim 15, wherein determining the second power transfer profile comprises:
determining that the determined wireless power transfer efficiency and the received rectifier power level are within an efficiency range on a curve associated with the second power transfer profile.

19. The method of claim 18, wherein determining the second power transfer profile comprises:
identifying the curve associated with the second power transfer profile using device type information received from the additional electronic device and at least one operating parameter.

20. A non-transitory computer-readable storage medium storing one or more programs configured to be executed by one or more processors of an electronic device comprising a wireless power transfer coil and an inverter that is configured to supply alternating-current drive signals to the wireless power transfer coil, the one or more programs including instructions for:
commencing wireless power transfer to an additional electronic device using a first power transfer profile, wherein the first power transfer profile defines a target output characteristic of the wireless power transfer coil;
during wireless power transfer to the additional electronic device using the first power transfer profile, receiving a first packet from the additional electronic device that comprises received power information for the additional electronic device;
using at least the received power information, determining a second power transfer profile, wherein the second power transfer profile provides more optimal power transfer between the electronic device and the additional electronic device than the first power transfer profile; and
transmitting a second packet to the additional electronic device that identifies the second power transfer profile.
